(19) United States
(12) Patent Application Publication
(10) Pub. No.: US 2016/0154955 A1
(43) Pub. Date: Jun. 2, 2016

(54) COMMUNICATION SYSTEM, ELECTRONIC DEVICE AND METHOD

(71) Applicant: Kabushiki Kaisha Toshiba, Tokyo (JP)

(72) Inventors: Hironori Motoe, Ome Tokyo (JP); Hiroshi Aiba, Ome Tokyo (JP)

(21) Appl. No.: 15/014,962

(22) Filed: Feb. 3, 2016

Related U.S. Application Data
(63) Continuation of application No. PCT/JP2013/084335, filed on Dec. 20, 2013.

(51) Int. Cl. G06F 21/36

(52) U.S. Cl. CPC G06F 21/36

(57) ABSTRACT

According to one embodiment, a terminal device includes a lock unit configured to lock input when not used, a first communication unit configured to receive a security code from an electronic device attachable to a user, and an unlock unit configured to release a state locked by the lock unit based on the security code received by the first communication unit.

### CROSS REFERENCE TO RELATED APPLICATIONS

This application is a Continuation application of PCT Application No. PCT/JP2013/084335, filed Dec. 20, 2013, the entire contents of which are incorporated herein by reference.

### FIELD

Embodiments described herein relate generally to a communication system, an electronic device and a method which are used for the communication system.

### BACKGROUND

A personal computer generally includes a locking function configured to prevent unauthorized operation by another person. The locking function is configured to be automatically activated when no input has been operated for a predetermined time or more. However, each release of the locking function involves a troublesome operation such as typing a password.

Meanwhile, an electronic device including a body area network (BAN) function as a body communication network has been prevalent and used in various fields in recent years. A BAN is a form of a communication system configured to use the human body, which is a dielectric material, as a communication medium, and a new and different communication system from a wired communication and a wireless communication.

A method of using a device including the above-described BAN function to allow a user to release a locking function by simply contacting a personal computer has been considered. However, the BAN function is configured to consume larger power consumption. The BAN function in a continuous on-state causes a power shortage of a battery and disables any other functions.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external configuration of a computer (terminal device) according to a first embodiment.

FIG. 2 is an exemplary view illustrating an external configuration of a wearable device (electronic device) according to the first embodiment.

FIG. 3 is an exemplary block diagram showing a system configuration of the computer according to the first embodiment.

FIG. 4 is an exemplary block diagram showing a system configuration of the wearable device according to the first embodiment.

FIG. 5 is an exemplary diagram showing a structure of a control program executed by the computer according to the first embodiment.

FIG. 6 is an exemplary diagram showing a structure of a control program executed by the wearable device according to the first embodiment.

FIG. 7 is an exemplary view illustrating a state where the computer according to the first embodiment is locked.

FIG. 8 is an exemplary view illustrating a state where a user touches a touchpad of the computer according to the first embodiment is locked.

FIG. 9 is an exemplary view illustrating a state where a user is inputting a character on the touchpad of the computer according to the first embodiment is locked.

FIG. 10 is an exemplary view illustrating a state after a user has input a character on the touchpad of the computer according to the first embodiment is locked.

FIG. 11 is an exemplary view illustrating a state where the computer according to the first embodiment is unlocked.

FIG. 12 is an exemplary flowchart showing operations during registration of a condition of the wearable device according to the first embodiment.

FIG. 13 is an exemplary flowchart showing operations of the computer according to the first embodiment and showing a process of the computer and a process of the wearable device.

FIG. 14 is an exemplary flowchart showing any other operations of the computer according to the first embodiment and showing a process of the computer and a process of the wearable device.

FIG. 15 illustrates an exemplary method of activating a BAN function of a wearable device according to a second embodiment.

FIG. 16 is an exemplary flowchart showing operations during registration of a condition of the wearable device according to the second embodiment.

FIG. 17 is an exemplary flowchart showing operations of the computer according to the second embodiment and showing a process of a computer and a process of the wearable device.

FIG. 18 is an exemplary flowchart showing operations of the computer according to a third embodiment and showing a process of a computer and a process of a wearable device.

### DETAILED DESCRIPTION

Various embodiments will be described hereinafter with reference to the accompanying drawings.

In general, according to one embodiment, a communication system includes a terminal device and an electronic device attachable to a user. The terminal device includes a lock unit configured to lock input when the terminal device is not used, a first communication unit configured to receive a security code from the electronic device, and an unlock unit configured to release a state locked by the lock unit based on the security code received by the first communication unit. The electronic device includes a second communication unit configured to transmit the security code, a motion detector configured to detect a motion of a user wearing the electronic device, and a first activation controller configured to activate the second communication unit based on the motion detected by the motion detector.

### First Embodiment

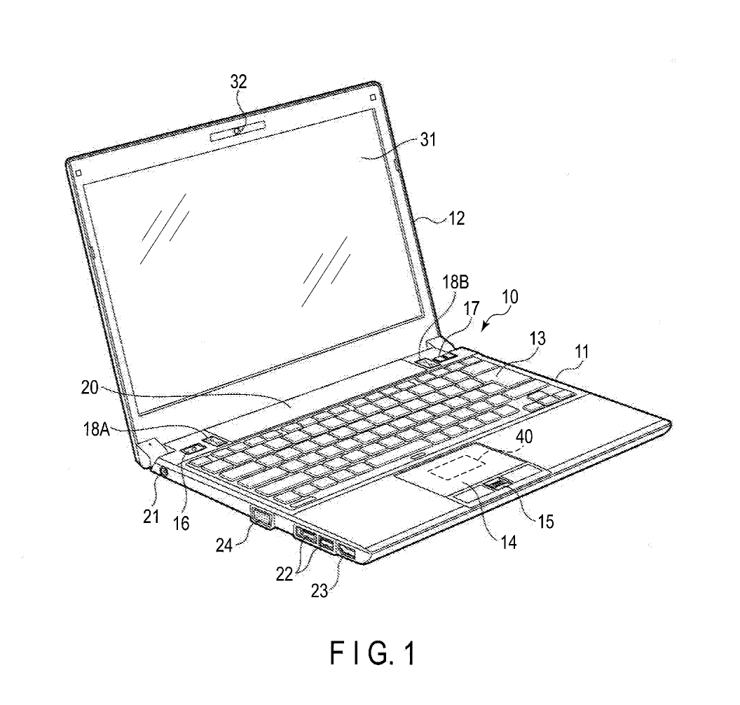

First, a configuration of a terminal device according to the embodiment will be described with reference to FIG. 1. The terminal device may be implemented as a notebook type personal computer, a tablet terminal or any other various information processing apparatuses. Hereinafter, assume that the terminal device is implemented as a personal computer 10 of a notebook type.

FIG. 1 is an exemplary perspective view illustrating the computer 10 where a display unit is in open state viewed from a front side.

The computer 10 includes a computer main unit 11 and a display unit 12. The display unit 12 is configured to incorporate a liquid crystal display (LCD) 31. The display unit 12 also includes a camera (Web camera) 32 arranged in an upper end portion.

The display unit 12 is attached to the main unit 11 rotatably between an open position where a top surface of the main unit 11 is exposed and a closed position where the top surface of the main unit 11 is covered with the display unit 12. The main unit 11 includes a thin box-type housing. The main unit 11 includes a keyboard 13, a touchpad 14, a fingerprint sensor 15, a power switch 16, a plurality of function buttons 17, and speakers 18A and 18B arranged in the upper surface.

The main unit 11 includes a power connector 21. The power connector 21 is located in a side surface such as a left side surface of the main unit 11. An external power supply is configured to detachably connect to the power connector 21. An AC adapter may be used as the external power supply. The AC adapter is a power supply configured to convert a commercial power supply (AC power) into DC power.

A battery 20 is detachably mounted on a portion such as a rear end portion of the main unit 11. The battery 20 may be a battery built in the computer 10.

The computer 10 is configured to operate with either power from the external power supply or power from the battery 20. The computer 10 is configured to operate with the power from the external power supply while the external power supply is connected to the power connector 21. The power from the external power supply is also used for charging the battery 20. The computer 10 is configured to operate with the power from the battery 20 while the external power supply is unconnected to the power connector 21.

The main unit 11 may include a plurality of USB ports 22, an HDMI (High-definition multimedia interface) output port 23, and an RGB port 24.

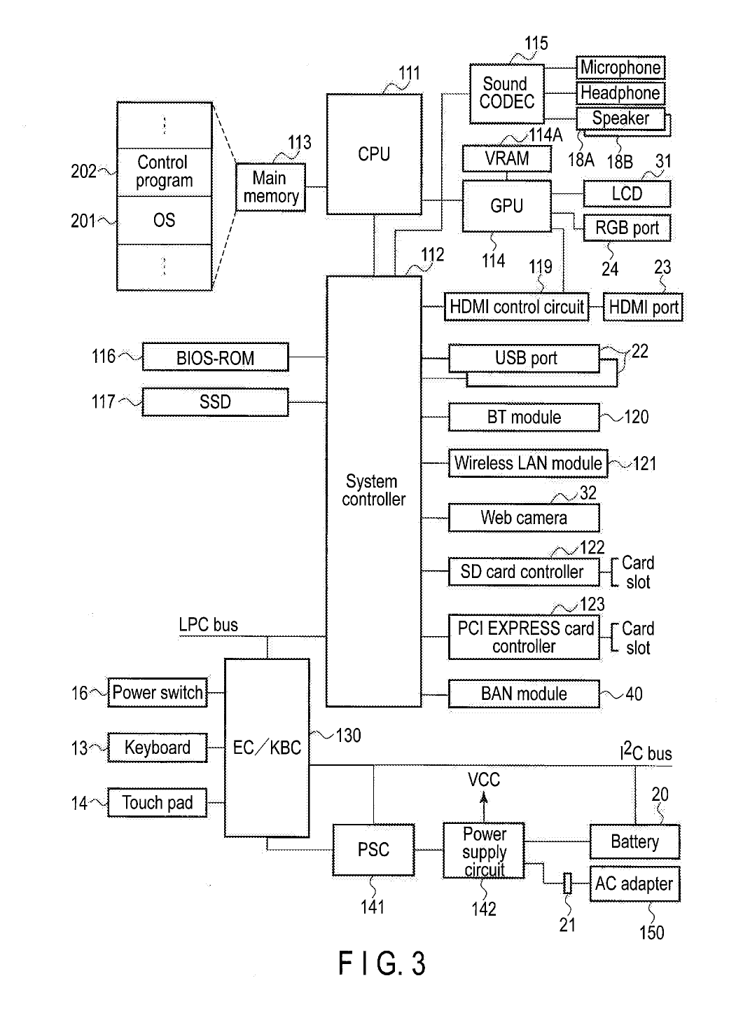

A BAN (Body Area Network) module 40 is located underneath the touchpad 14 of the computer 10. The BAN module 40 is configured to use a human body, which is a dielectric material, as a communication medium to communicate. A detailed system configuration of the computer 10 will be described below with reference to FIG. 3.

Next, a wearable device 1 used as an electronic device according to the embodiment will be described. The wearable device 1 which is a BAN-enabled device, is configured to communicate with the computer 10 while a user is wearing the wearable device 1.

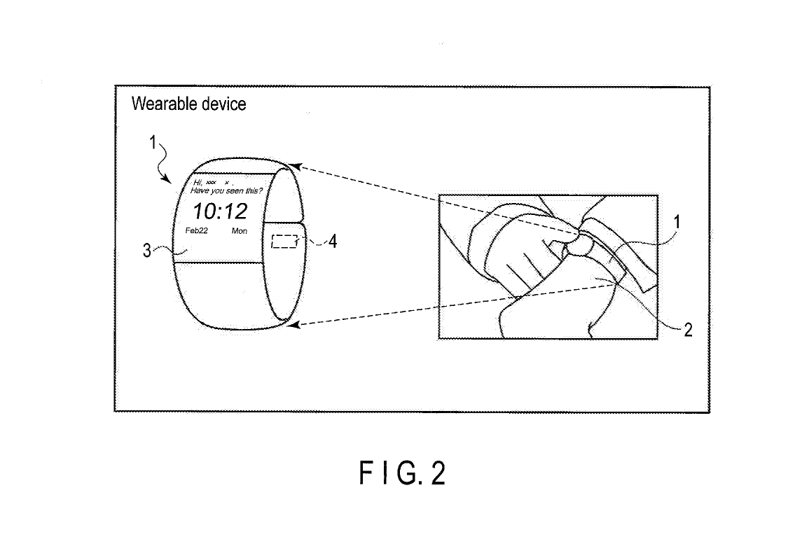

FIG. 2 is a view illustrating an example of an external configuration of the wearable device 1.

The wearable device 1 is configured to be attachable to the human body. The form of the wearable device 1 may include, for example, a wrist watch (bracelet type) device configured to be worn on a list of a user, a simple device which has no display and is attachable to any body part of a user, and a glasses device configured to be used as eyeglasses. Hereinafter, assume that the wearable device 1 is implemented by the wrist watch (bracelet type) device.

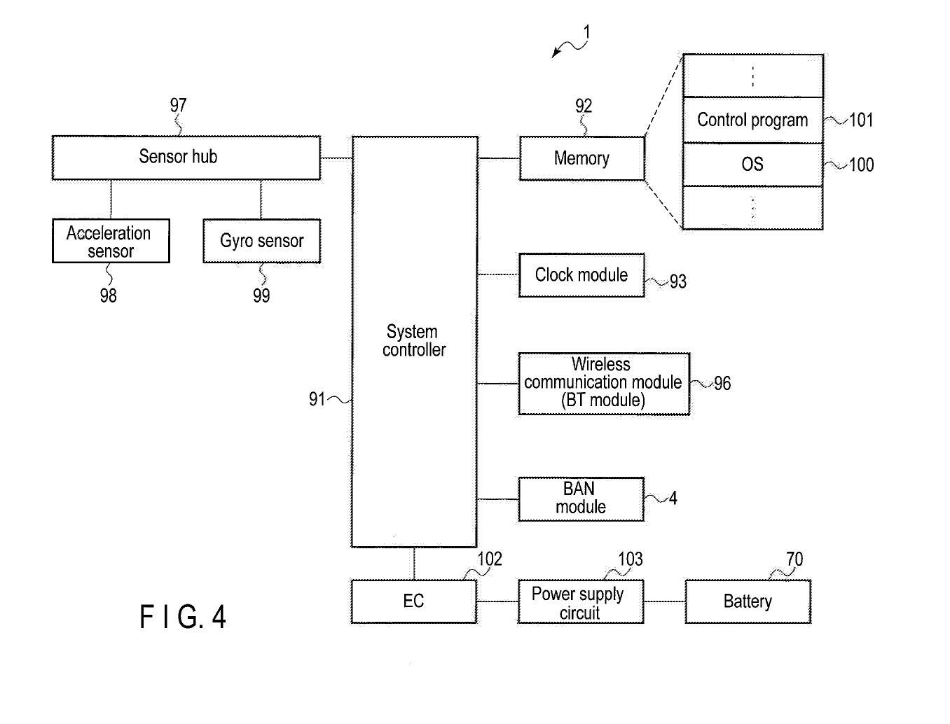

The wearable device 1 may be configured to be worn on a part of a user's hand, specifically a wrist 2 of either a right hand or a left hand of the user. The wearable device 1 includes a display 3 and a BAN module 4. The BAN module 4 is arranged in opposite to the display 3 and is located in a belt of the wearable device 1 while the wearable device 1 is worn on the wrist 2 of the user. A detailed system configuration of the wearable device 1 will be described below with reference to FIG. 4.

The wearable device 1 is configured to operate with the battery and to provide various information to the user who wears the wearable device 1. The wearable device 1 which includes a near-field wireless communication such as Bluetooth (registered trademark), is configured to use the near-field wireless communication to synchronize data stored in the wearable device 1 and data stored in the computer 10. The wearable device 1 is configured to synchronize, for example, user's schedule data stored in the computer 10 and user's schedule data stored in the wearable device 1.

The wearable device 1 is configured to provide various information associated with the user as an owner of the wearable device 1. The various information associated with a user may include the information such as schedule information, weather information, location information of the wearable device 1, and traffic information.

The wearable device 1 is configured to use the BAN module 4 to communicate with the computer 10 using the user as a medium. In the embodiment, the BAN module 4 is used when a security code for releasing a locked state of the computer 10 is transmitted from the wearable device 1 to the computer 10.

FIG. 3 is an exemplary block diagram illustrating the system configuration of the computer 10.

The computer 10 may include a CPU 111, a system controller 112, a main memory 113, a graphics processing unit (GPU) 114, a sound codec 115, a BIOS-ROM 116, and a solid-state drive (SSD) 117. The computer 10 may also includes the BAN module 40, a Bluetooth (registered trademark) module 120, a wireless LAN module 121, an SD card controller 122, a PCI EXPRESS card controller 123, an embedded controller/keyboard controller IC (EC/KBC) 130, a power supply controller (PSC) 141, and a power supply circuit 142.

The CPU 111 is a processor configured to control the operation of each component of the computer 10. The CPU 111 is configured to run various software loaded from the SSD 117 into the main memory 113. The software includes an operating system (OS) 201 and a control program 202.

The control program 202 is configured to provide various functions in conjunction with the wearable device 1. The control program 202 is configured to execute, for example, the function for using the near-field wireless communication to synchronize the data between the computer 10 and the wearable device 1, the function for controlling the computer 10 locked or unlocked, and the function for controlling the touchpad 14 enabled or disabled.

The CPU 111 is configured to also run a basic input/output system (BIOS) stored in the BIOS-ROM 116, which is a nonvolatile memory. The BIOS is a system program for executing hardware control.

The GPU 114 is a display controller for controlling the LCD 31 used as a display monitor of the computer 10. The GPU 114 is configured to generate a display signal (an LVDS signal) to be supplied to the LCD 31, from display data stored in a video memory (VRAM) 114A. The GPU 114 is configured to also generate analog RGB signals and an HDMI video signal from the display data. The analog RGB signals are supplied through the RGB port 24 to an external display.

The HDMI output port 23 is configured to output the HDMI video signal (an uncompressed digital video signal) and a digital audio signal to the external display with the help of a single cable. An HDMI control circuit 119 is an interface for outputting the HDMI video signal and the digital audio signal to the external display through the HDMI output port 23.

The system controller 112 is a bridge device for connecting the CPU 111 to each of the components. The system controller 112 includes a built-in serial ATA controller for controlling the SSD 117. The system controller 112 is configured to communicate with each device on a Low Pin Count (LPC) bus.

The EC/KBC 130 is connected to the LPC bus. The EC/KBC 130, the power supply controller (PSC) 141, and the battery 20 are connected to one another through a serial bus such as an I²C bus.

The EC/KBC 130 is a power management controller for performing power management of the computer 10. The EC/KBC 130 is, for example, implemented as a one-chip microcomputer with a built-in a keyboard controller for controlling the keyboard (KB) 13 and the touchpad 14.

The EC/KBC 130 is configured to cause the computer 10 to be turned on or off in response to the user's operation of the power switch 16. The control for causing the computer 10 to be turned on or off is achieved by the cooperation between the EC/KBC 130 and the power supply controller (PSC) 141. The power supply controller (PSC) 141 is configured to control the power supply circuit 142 and to turn the computer 10 on upon receiving an ON signal transmitted from the EC/KBC 130. The power supply controller (PSC) 141 is configured to control the power supply circuit 142 and to turn the computer 10 off upon receiving an OFF signal transmitted from the EC/KBC 130. The EC/KBC 130, the power supply controller (PSC) 141, and the power supply circuit 142 are configured to keep operating, even if the computer 10 is powered off, using electric power supplied from the battery 20 or an AC adapter 150.

The power supply circuit 142 is configured to use the electric power from the battery 20 or the electric power from the AC adapter 150, which is connected to the main unit 11 as an external power source, to generate electric power (operation power) to be supplied to each component.

The BAN module 40 is configured to use a user as a medium to communicate with the wearable device 1. As illustrated in FIG. 1, the BAN module 40 is located underneath the touchpad 14 of the computer 10. The BAN module 40 is configured to transmit and receive data to/from the wearable device 1 while the user wearing the wearable device 1 touches the touchpad 14.

The touchpad 14 is configured to employ a method for detecting a touch position of the user based on a change of capacitance. Accordingly, incorporation of the BAN module 40 into the touchpad 14 enables communication by using a BAN through the user, which is a dielectric material, in principle.

FIG. 4 is an exemplary block diagram showing a system configuration of the wearable device 1.

The wearable device 1 may include a system controller 91, a memory 92, a clock module 93, a wireless communication module (Bluetooth module) 96, a sensor hub 97, an EC 102, and a power supply circuit 103.

The system controller 91 is a processor configured to control the operation of each component within the wearable device 1. The system controller 91 is configured to execute an operating system (OS) 100 and a control program 101 loaded into the memory 92.

The control program 101 is configured to provide the various functions in conjunction with the computer 10. For example, the control program 101 is configured to use the near-field wireless communication to synchronize the data between the computer 10 and the wearable device 1.

The system controller 91 includes a built-in memory controller for controlling access of the memory 92. The system controller 91 may also include a built-in display controller for controlling the display 3 of the wearable device 1.

The clock module 93 is configured to clock a current time point. The wireless communication module (Bluetooth module) 96 is a wireless communication device configured to wirelessly communicate with using Bluetooth (registered trademark).

The BAN module 4 is configured to use a user as a medium to communicate with the computer 10. As illustrated in FIG. 2, the BAN module 4 is located in the belt of the wearable device 1 in form of wrist watch. The BAN module 4 is configured to contact the wrist 2 of the user when the user wears the wearable device 1.

An acceleration sensor 98 and a gyro sensor 99, which are motion sensors, are connected to the sensor hub 97. The sensors 98 and 99 enable a motion of the wearable device 1, that is, an action of the user wearing the wearable device 1 to be detected.

The EC 102 is a power management controller for performing power management of the wearable device 1. The EC 102 and the power supply circuit 103 are configured to keep operating, even if the wearable device 1 is powered off, using electric power supplied from a battery 70. The power supply circuit 103 is configured to use the electric power supplied from the electric power from the battery 70 to generate the electric power (operation power) to be supplied to each component.

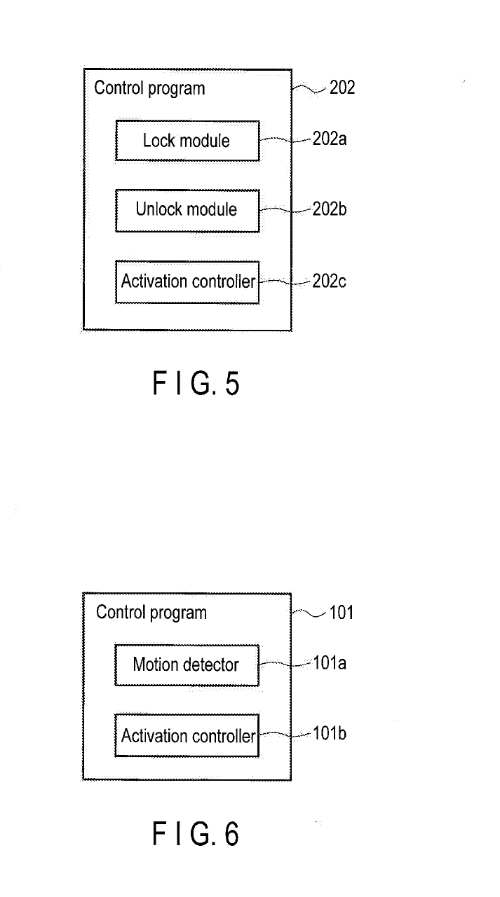

FIG. 5 is an exemplary diagram showing a structure of the control program 202 executed by the computer 10.

The control program 202 may include a lock module 202a, an unlock module 202b, and an activation controller 202c, which are the functions involved in the embodiment. The lock module 202a is configured to lock input into the computer 10 while the user is not using the computer 10. The unlock module 202b is configured to release the locked state in accordance with the security code. The activation controller 202c is configured to control the activation of the BAN function based on a character recognized on the touchpad 14 of the computer 10.

FIG. 6 is an exemplary diagram showing a structure of the control program 102 executed by the wearable device 1.

The control program 101 may include a motion detector 101a and an activation controller 101b, which are the functions involved in the embodiment. The motion detector 101a is configured to detect the motion of the user wearing the wearable device 1. Specifically, the motion detector 101a is configured to detect the motion of the user drawing a character and a tilt angle of the user's hand operating the computer 10 based on the signal from the motion sensors in the wearable device 1. The activation controller 101b is configured to control the activation of the BAN function based on the motion of the user.

Prior to describing operation of the system according to the embodiment, a method of using the wearable device 1 to release a locked state of the computer 10 will be described.

The computer 10 is set in the locked state when no input is detected even after the lapse of a predetermined time period. The computer 10 and the wearable device 1 are configured to store the security code for unlocking and to be paired each other, in advance. The finger of the user wearing the wearable device 1 touches the touchpad 14 of the computer 10, which causes the security code to be transmitted through the user's finger to the computer 10, using the BAN function (BAN module 4) of the wearable device 1. The BAN function (BAN module 40) of the computer 10 is configured to receive the security code. The computer 10 is configured to decode the security code and to release the locked state when the security code matches the correct code.

Such a system configured to use the BAN function to release the locked state of the computer 10 needs to keep the BAN functions of both of the computer 10 and the wearable device 1 in a continuous on-state (active state), which causes the electric power to be unnecessarily consumed during the active state. Especially, storage capacity of the battery 70 of the wearable device 1 is quite small. Accordingly, the BAN function in a continuous on-state causes a power shortage and disables any other functions.

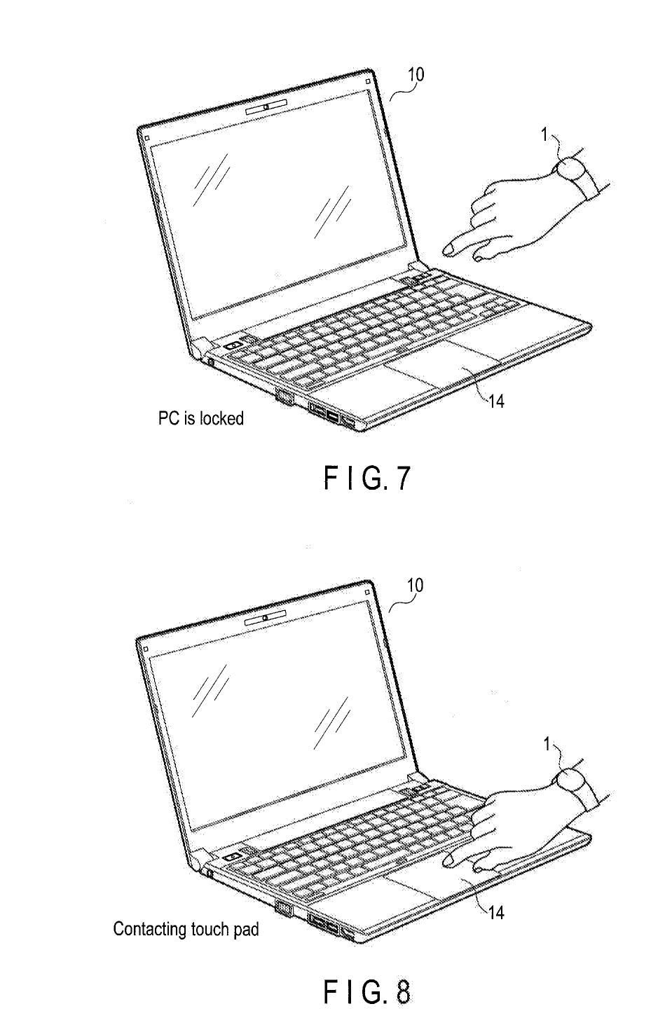

Therefore, detecting the motion of the user is configured to enable the BAN function when the user operates the computer 10. FIGS. 7 to 11 illustrate the above-described states.

FIG. 7 illustrates a state where the computer 10 is locked. The BAN functions of the computer 10 and the wearable device 1 are disabled at this time. Consequently, the user's touch on the touchpad 14 alone does not allow the user to unlock, as illustrated in FIG. 8.

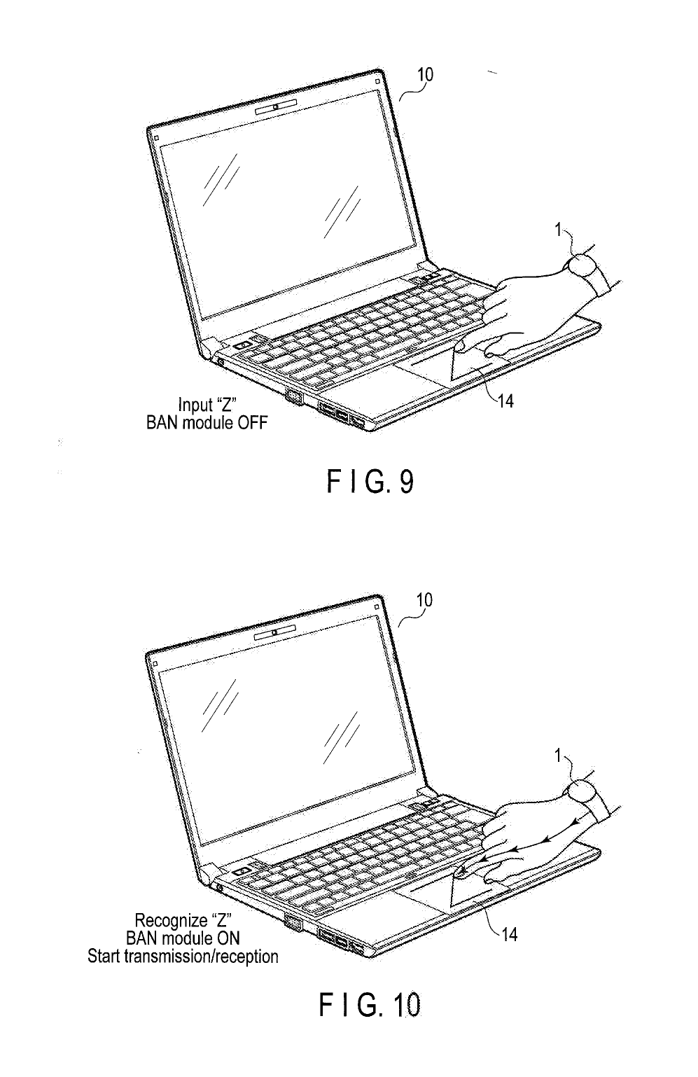

The touchpad 14 includes a gesture function for detecting character input. The character detected by the gesture function is pre-registered as an activation condition of the BAN function. The same character as above-described character is pre-registered in the wearable device 1 as the activation condition of the BAN function. In FIGS. 9 and 10, assume that the character “Z” is registered as the activation condition of the BAN function.

As illustrated in FIG. 9, the user inputs the character “Z” by handwriting on the touchpad 14 of the computer 10. Meanwhile, the BAN functions of the computer 10 and the wearable device 1 are disabled.

FIG. 10 illustrates a state after the user has input the character “Z”. As the character “Z” is recognized by the gesture function of the touchpad 14, the BAN function of the computer 10 is enabled and in a receiving state. Meanwhile, the motion of the user inputting the character “Z” is detected by the acceleration sensor 98 and the gyro sensor 99 in the wearable device 1. Upon detection of the inputting motion of the character “Z”, the BAN function of the wearable device 1 is enabled and in a transmitting state.

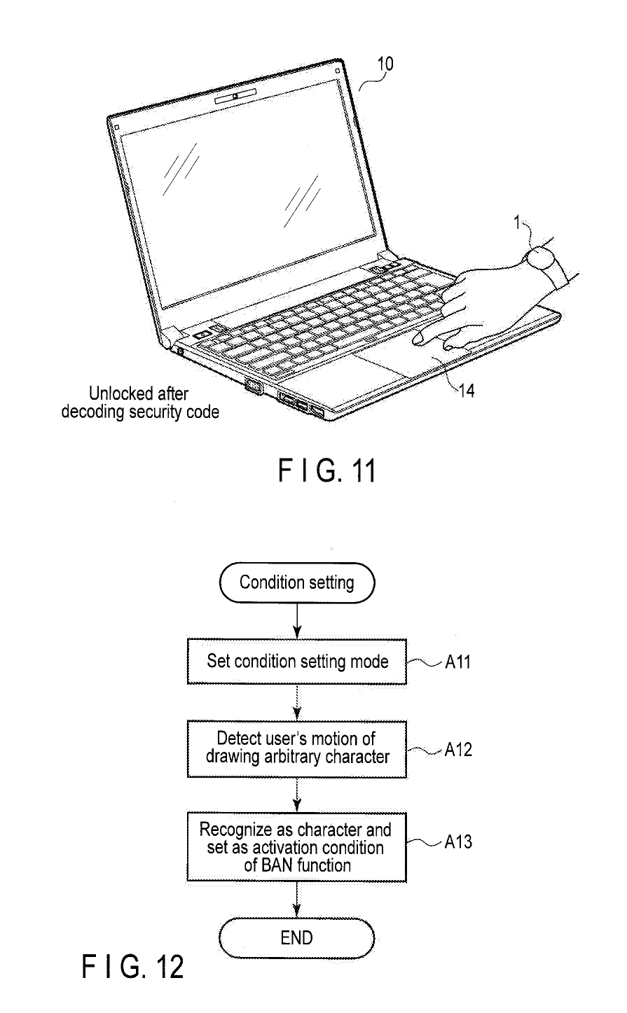

Thus, the BAN functions of the computer 10 and the wearable device 1 are enabled, which causes the security code to be transmitted from the wearable device 1 through the user's finger to the computer 10. As illustrated in FIG. 11, the computer 10 is configured to receive and decode the security code to release the locked state. The transmission and reception time of the BAN function is within a certain time (for example, about 5 to 10 seconds). After releasing the locked state, the BAN functions of the computer 10 and the wearable device 1 are configured to be disabled.

Next, the operation of the system according to the embodiment performed (a) at the time of condition registration and (b) at the time of operating the computer will be described in detail.

(a) At the Time of Condition Registration

FIG. 12 is a flowchart showing operations during registration of a condition of the wearable device 1. The processing indicated by this flowchart is executed by causing the system controller 91 of the wearable device 1 to read a program associated with this operation, which is included in the control program 101 stored in the memory 92.

For example, a condition registration mode is set in the wearable device 1 by an instruction from the computer 10 while the computer 10 and the wearable device 1 are connected through the wireless communication (block A11).

The user may draw an arbitrary character on the touchpad 14 of the computer 10 while the user wears the wearable device 1 on the wrist 2. The system controller 91 is configured to detect the motion of the wearable device 1 at this time with the acceleration sensor 98 and the gyro sensor 99 (step A12). The system controller 91 is configured to recognize the user's drawn character from the path of the motion of the wearable device 1 and to register this character as the activation condition of the BAN function, in a predetermined area in the memory 92 (step A13).

The same character as above-described character is registered also in the computer 10 as the activation condition. In this case, the user's drawn character on the touchpad 14 is detected and registered as the activation condition of the BAN function, in a predetermined area in the main memory 113.

For example, supposing that the user has drawn a character “Z” on the touchpad 14 while the user wears the wearable device 1 on the wrist 2, the character “Z.” is registered as the activation condition of the BAN functions of the computer 10 and the wearable device 1.

(b) At the Time of Operating the Computer

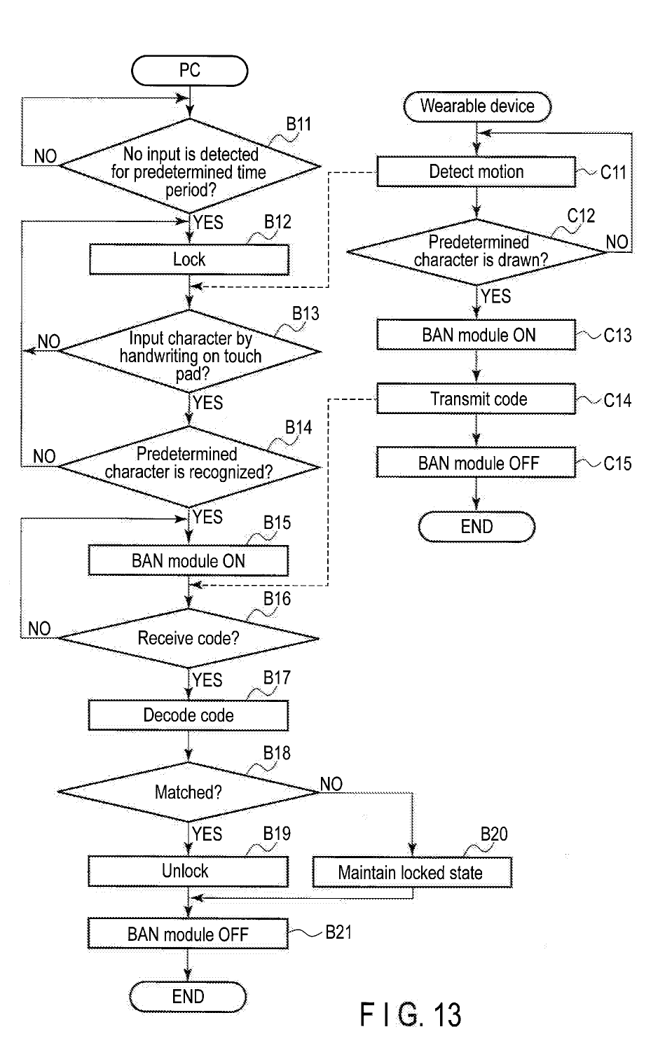

FIG. 13 is a flowchart showing operations of the computer 10 and showing a process of the computer 10 and a process of the wearable device 1. The processing in the computer 10 is executed by causing the CPU 111 to read a program associated with this operation, which is included in the control program 202 stored in the main memory 113. The processing in the wearable device 1 is executed by causing the system controller 91 to read a program associated with this operation, which is included in the control program 101 stored in the memory 92.

When no input is detected even after the lapse of a predetermined time period while the computer 10 is switched on (Yes in step B11), the CPU 111 is configured to make the computer 10 in locked state (step B12). The term “locked state” indicates a state in which any input operation is unacceptable in the computer 10. At this time, a display screen maybe concealed with, for example, a screen saver.

When the user wearing the wearable device 1 on the wrist 2 inputs a character by handwriting on the touchpad 14 (Yes in step B13), the CPU 111 of the computer 10 is configured to recognize and process the input character (step B14). If the recognized character is a character (for example, “Z”) pre-registered as the activation condition (Yes in step B14), the CPU 111 is configured to enable the BAN function (BAN module 40) (step B15).

Meanwhile, the system controller 91 of the wearable device 1 is configured to detect the motion of the wearable device when the user draws the character on the touchpad 14 (step C11). If the detected motion of the wearable device 1 is a motion corresponding to the character (for example, “Z”) pre-registered as the activation condition (Yes in step C12), the system controller 91 is configured to enable the BAN function (BAN module 4) (step C13).

When the BAN function is enabled, the system controller 91 is configured to read the security code for unlocking from the memory 92 and to transmit the security code to the computer 10 through the finger of the user touching the touchpad 14 of the computer 10 (step C14).

The security code transmitted to the computer 10 is received by the BAN module 40 located underneath the touchpad 14 (step B16) and decoded by predetermined decoding processing (step B17). The CPU 111 is configured to compare the received code with the predetermined security code and to release the locked state (step B19) when both codes match (Yes in step B18). The term “release locked state” indicates a state in which any normal input operation is available. The CPU 111 is configured to maintain the locked state (step B20) when the received code does not match the predetermined security code (No in step B18).

For reduction of the power consumption of the BAN functions, the BAN functions of the wearable device 1 and computer 10 are configured to be disabled, after the lapse of a certain time (for example, about 5 s to about 10 s) after transmission and reception of the security code (steps B21 and C15).

As described above, the BAN function, which consumes larger power consumption, is configured to operate for a short time only when operating the computer 10. This greatly reduces the power consumption compared with a configuration of which the BAN function is in a continuous operating state. Especially, the wearable device 1 is configured to operate only with the power of the battery with quite small storage capacity. The reduction of electric power consumed by the BAN function increases device operating time.

In the example of FIG. 13, the user draws the character on the touchpad 14 of the computer 10, which causes the BAN functions of the computer 10 and the wearable device 1 to be enabled simultaneously. The BAN functions of the computer 10 and the wearable device 1 do not necessarily need to be enabled simultaneously. Alternatively, the BAN function of the computer 10 may be enabled after the BAN function of the wearable device 1 enabled.

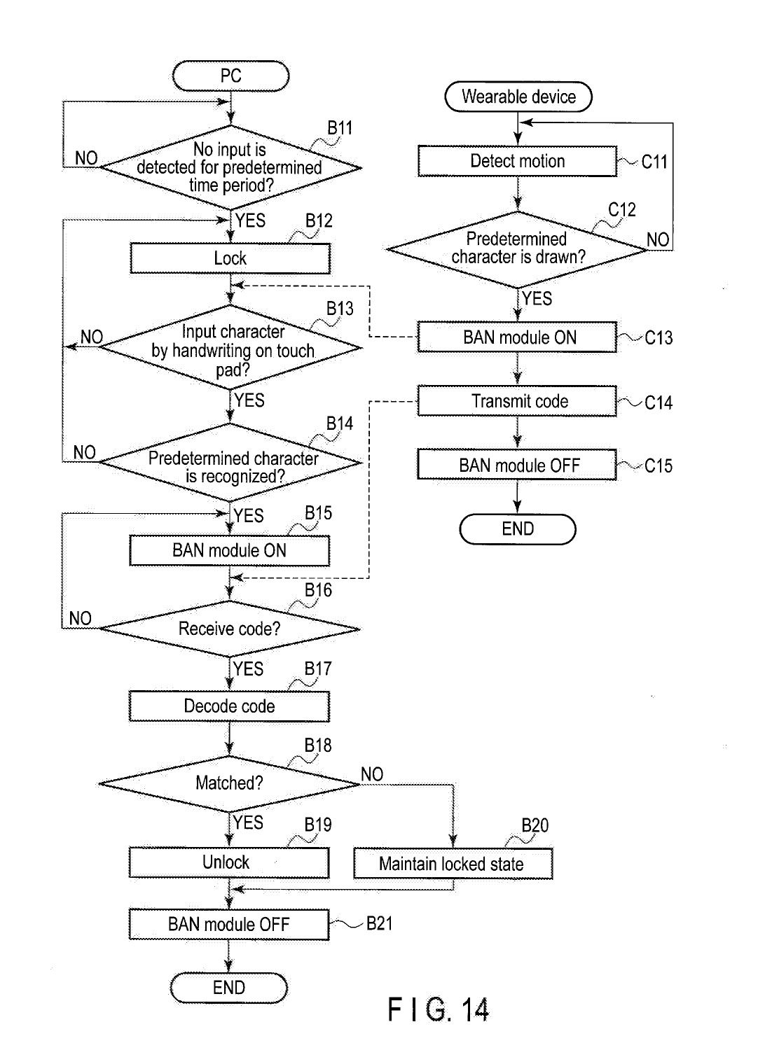

FIG. 14 illustrates the above-described states with dotted lines. First, a user moves only his or her finger to draw a character registered as the activation condition, without touching the touchpad 14 of the computer 10. This ensures that only the BAN function of the wearable device 1 is enabled. Subsequently, the user touches the touchpad 14 of the computer 10 and then draws the character registered as the activation condition on the touchpad 14. This ensures that the BAN function of the computer 10 is enabled. The subsequent steps are identical to those in FIG. 13. The security code is transmitted from the wearable device 1 to the computer 10, which causes the locked state of the computer 10 to be released.

### Second Embodiment

A second embodiment will be described.

In the first embodiment described above, detection of a motion of a user drawing a predetermined character enables the BAN function only when operating the computer. In contrast, in the second embodiment, detection of a tilt angle of a wrist of the user operating the computer enables a BAN function.

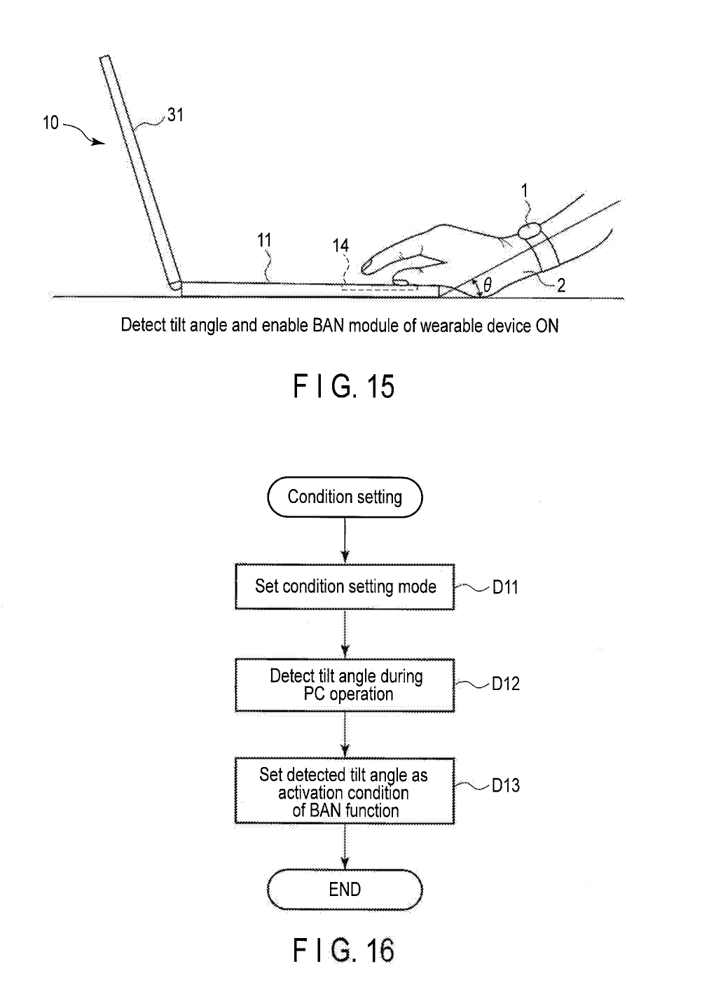

FIG. 15 illustrates a method of activating the BAN function of a wearable device 1 according to the second embodiment.

The user wears the wearable device 1 in form of wrist watch on the wrist 2. The tilt angle θ of the wrist 2 of the user operating the computer 10 (a tilt angle of the wearable device 1) is detected with using an acceleration sensor 98. In this case, assume that the main unit 11 is on a horizontal plane and the user operates the touchpad 14 arranged on an upper surface of the main unit 11.

Upon detection of a predetermined angle θ, the BAN function of the wearable device 1 is enabled. For example, if the predetermined angle θ is 30°, the BAN function is configured to be enabled when the wearable device 1 tilts 30° with respect to the horizontal plane.

The user may not always operate the computer 10 at a constant same angle. Accordingly, a range of angle that contains the predetermined angle θ and a certain number of degrees as a margin is preferably set as an activation condition of the BAN function. For example, if the predetermined angle θ is 30°, the range of 25 to 35° containing the margin of plus or minus 5° is set in the activation condition of the BAN function.

The computer 10 and the wearable device 1 are similar in basic structure to those of the above-described first embodiment. The operation of the system according to the second embodiment performed (c) at the time of condition registration and (d) at the time of operating the computer will be described below in detail.

(c) At the Time of Condition Registration

FIG. 16 is a flowchart showing operations during registration of a condition of the wearable device 1. The processing indicated by this flowchart is executed by causing the system controller 91 of the wearable device 1 to read a program associated with this operation, which is included in the control program 101 stored in the memory 92.

For example, a condition registration mode is set in the wearable device 1 by an instruction from the computer 10 while the computer 10 and the wearable device 1 are connected through wireless communication (step D11).

The user places his or her hand on the touchpad 14 of the computer 10 while the user wears the wearable device 1 on the wrist 2. The system controller 91 is configured to detect the tilt angle θ (tilt angle of the wearable device 1) of the user's wrist 2 at this time as an angle during the computer operation with the acceleration sensor 98 (step D12). The system controller 91 is configured to add a predetermined margin to the detected tilt angle θ to register the angular range as the activation condition of the BAN function, in a predetermined area in the memory 92 (step D13).

(d) At the Time of Operating the Computer

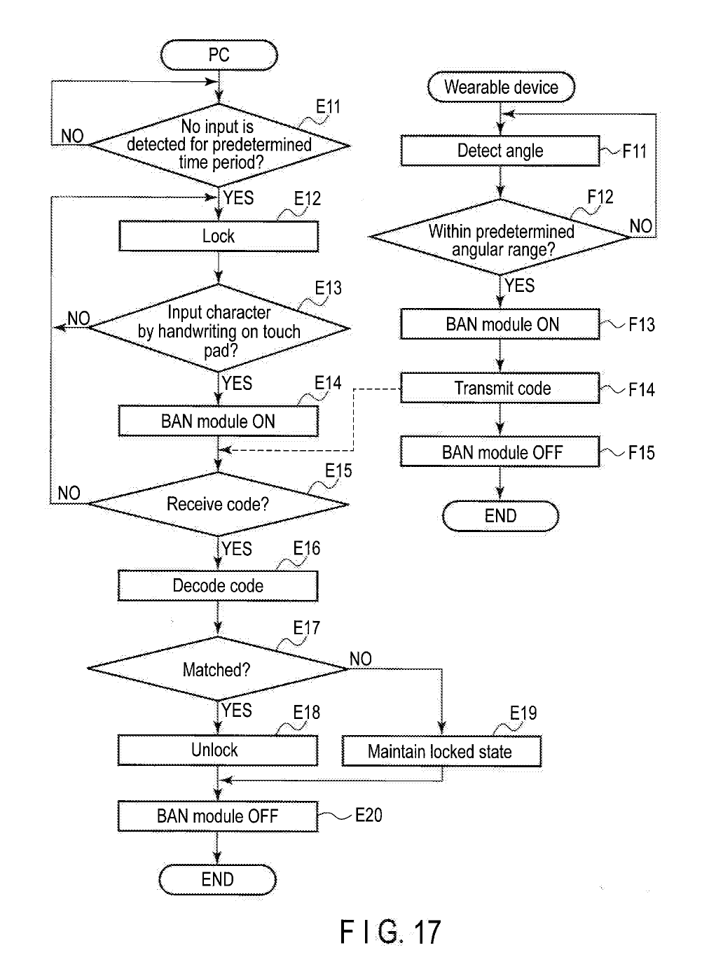

FIG. 17 is a flowchart showing operations of the computer and showing a process of the computer 10 and a process of the wearable device 1. The processing in the computer 10 is executed by causing the CPU 111 to read a program associated with this operation, which is included in the control program 202 stored in the main memory 113. The processing in the wearable device 1 is executed by causing the system controller 91 to read a program associated with this operation, which is included in the control program 101 stored in the memory 92.

When no input is detected even after the lapse of a predetermined time period while the computer 10 is switched on (Yes in step E11), the CPU 111 is configured to make the computer 10 in locked state (step E12). The term “locked state” indicates a state in which any input operation is unacceptable in the computer 10. At this time, a display screen may be concealed with, for example, a screen saver.

When the user wearing the wearable device 1 on the wrist 2 contacts the touchpad 14 (Yes in step E13), the CPU 111 is configured to enable the BAN function (BAN module 40) (step E14).

Meanwhile, the system controller 91 of the wearable device 1 is configured to detect the tilt angle θ (tilt angle of the wearable device 1) of the wrist 2 of the user touching the touchpad 14 of the computer 10 with the acceleration sensor 98 (step F11). If the detected tilt angle θ is within an angular range pre-registered as the activation condition (Yes in step F12), the system controller 91 is configured to enable the BAN function (BAN module 4) (step F13).

The subsequent steps are identical to those of the above-described first embodiment. More specifically, the BAN functions of the computer 10 and the wearable device 1 are enabled, which causes the security code to be transmitted from the wearable device 1 through the user's finger to the computer 10 (step F14). The computer 10 is configured to decode the security code transmitted from the wearable device 1. The computer 10 is configured to release the locked state when the decoded code matches the predetermined code, and to maintain the locked state when the decoded code does not match the predetermined code (steps E15 to E19).

For reduction of power consumption of the BAN functions, the BAN functions of the wearable device 1 and computer 10 are configured to be disabled, after the lapse of a certain time (for example, about 5 to 10 seconds) after transmission and reception of the security code (steps E20 and F15).

As described above, the BAN function is configured to be enabled for a short time, based on the activation condition of a tilt of the wrist 2 of the user operating the computer 10. This reduces the power consumption of the BAN function, similarly to the above-described first embodiment.

### Third Embodiment

A third embodiment will be described.

In the third embodiment, a combination of the first embodiment and the second embodiment described above will be employed. For a wearable device 1, a BAN function is configured to be enabled based on activation conditions of a character and a tilt angle.

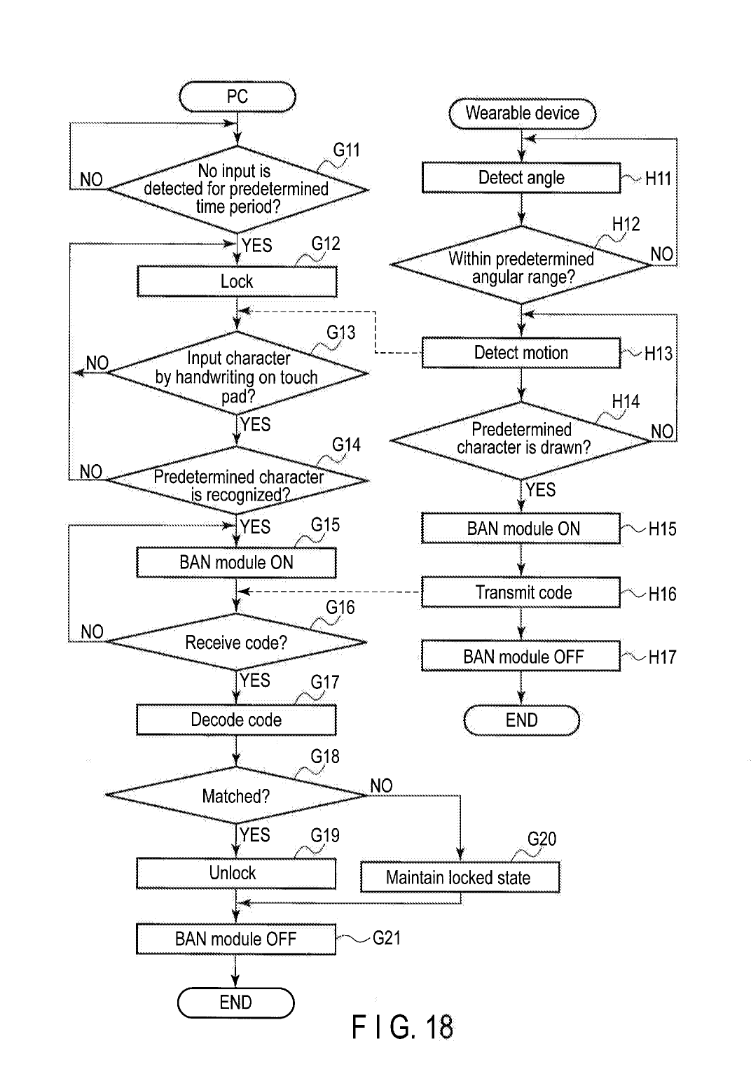

FIG. 18 is a flowchart showing the operations of a computer according to the third embodiment and showing a process of a computer 10 and a process of a wearable device 1. The computer 10 is configured to pre-register an arbitrary character as the activation condition. The wearable device 1 is configured to pre-register an arbitrary character and a range of tilt angle during the computer operation as the activation conditions.

When no input is detected even after the lapse of a predetermined time period while the computer 10 is switched on (Yes in step G11), the CPU 111 is configured to make the computer 10 in locked state (step G12). The term “locked state” indicates a state in which any input operation is unacceptable in the computer 10. At this time, a display screen is concealed with, for example, a screen saver.

When a user wearing the wearable device 1 on the wrist 2 inputs a character by handwriting on the touchpad 14 (Yes in step G13), the CPU 111 of the computer 10 is configured to recognize and process the input character (step G14). If the recognized character is a character (for example, “Z”) pre-registered as the activation condition (Yes in step G14), the CPU 111 is configured to enable the BAN function (BAN module 40) (step G15).

Meanwhile, the system controller 91 of the wearable device 1 is configured to detect a tilt angle θ (a tilt angle of the wearable device 1) of the wrist 2 of the user touching the touchpad 14 of the computer 10 with an acceleration sensor 98 (step H11). If the detected tilt angle θ is within an angular range pre-registered as the activation condition (Yes in step H12), the system controller 91 is subsequently configured to detect a motion of the wearable device when the user draws the character on the touchpad 14 (step H13). If the detected motion of the wearable device 1 is a motion corresponding to the character (for example, “Z”) pre-registered as the activation condition (Yes in step H14), the system controller 91 is configured to enable the BAN function (BAN module 4) (step H15).

The subsequent steps are identical to those of the above-described first embodiment. More specifically, the BAN functions of the computer 10 and the wearable device 1 are enabled, which causes a security code to be transmitted from the wearable device 1 through the user's finger to the computer 10 (step H16). The computer 10 is configured to decode the security code transmitted from the wearable device 1. The computer 10 is configured to release the locked state when the decoded code matches the predetermined code, and to maintain the locked state when the decoded code does not match the predetermined code (steps G16 to G20).

For reduction of power consumption of the BAN functions, the BAN functions of the wearable device 1 and computer 10 are configured to be disabled, after the lapse of a certain time (for example, about 5 to 10 seconds) after transmission and reception of the security code (steps G21 and H17).

As described above, combining a character and a tilt angle more reliably detects a state of user operating the computer to enable the BAN function.

According to any of the above-described embodiments, it can be provided a communication system, an electronic device, and a method for improving a power saving by activating the BAN function only when needed.

The processing procedures of the present embodiments can be performed by a computer program. Therefore, same effects as in the present embodiments can be readily achieved by installing the computer program on a computer to execute through a computer-readable recording medium storing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising a terminal device and an electronic device attachable to a user, wherein
the terminal device comprises:
a lock controller configured to lock input when the terminal device is not used;
a first communication controller configured to receive a security code from the electronic device; and
an unlock controller configured to release a state locked by the lock controller based on the security code received by the first communication controller, and
the electronic device comprises:
a second communication controller configured to transmit the security code;
a sensor configured to detect a motion of a user wearing the electronic device; and
a first activation controller configured to activate the second communication controller based on the motion detected by the sensor.

2. The communication system of claim 1, wherein
the sensor is configured to detect the motion of the user drawing a character; and
the first activation controller is configured to activate the second communication controller when the sensor detects a character being pre-registered as an activation condition.

3. The communication system of claim 1, wherein
the sensor is configured to detect a tilt angle of a hand of the user, and
the first activation controller is configured to activate the second communication controller when the sensor detects a tilt angle being pre-registered as the activation condition.

4. The communication system of claim 1, wherein
the terminal device further comprises:
a touchpad configured to input a character by handwriting and recognize the character; and
a second activation controller configured to activate the first communication controller based on the character recognized by the touchpad.

5. The communication system of claim 1, wherein
the electronic device comprises a housing formed like a wrist watch attachable to a wrist of the user.

6. The communication system of claim 1, wherein
each of the first communication controller and the second communication controller comprises a body area network and is configured to communicate a signal between the electronic device and the terminal device by using the user as a communication medium.

7. An electronic device attachable to a user, comprising:
a communication controller configured to communicate with a terminal device;
a sensor configured to detect a motion of the user; and
an activation controller configured to activate the communication unit based on the motion detected by the sensor.

8. The electronic device of claim 7, wherein
the sensor is configured to detect the motion of the user drawing a character, and
the activation controller is configured to activate the communication controller when the sensor detects a character being pre-registered as an activation condition.

9. The electronic device of claim 7, wherein
the sensor is configured to detect a tilt angle of a hand of the user; and
the activation controller is configured to activate the communication controller when the sensor detects a tilt angle being pre-registered as the activation condition.

10. The electronic device of claim 7, wherein
the electronic device comprises a housing formed like a wrist watch attachable to a wrist of the user.

11. The electronic device of claim 7, wherein
the communication controller comprises a body communication network and communicate with the terminal device by using the user as a communication medium.

12. A method for releasing a locked state of a terminal device with an electronic device attachable to a user, the electronic device comprising a communication controller, the method comprising:
detecting a motion of a user wearing the electronic device;
activating the communication controller based on the detected motion of the user; and
transmitting a security code to the terminal device.

13. The method of claim 12, further comprising:
detecting a motion of the user drawing a first character; and
activating the communication controller when a character pre-registered as an activation condition is detected.

14. The method of claim 12, further comprising:
detecting a tilt angle of a hand of the user; and
activating the communication controller when a tilt angle pre-registered as an activation condition is detected.
